(19) United States
(12) Patent Application Publication
(10) Pub. No.: US 2026/0025366 A1
(43) Pub. Date: Jan. 22, 2026

(54) SECRET DATA COMMUNICATION SYSTEM, AND SECRET DATA COMMUNICATION CONTROL APPARATUS, METHOD, AND NON-TRANSITORY COMPUTER-READABLE MEDIUM

(71) Applicant: NEC Corporation, Tokyo (JP)

(72) Inventor: Takao OCHI, Tokyo (JP)

(73) Assignee: NEC Corporation, Tokyo (JP)

(21) Appl. No.: 19/257,760

(22) Filed: Jul. 2, 2025

(30) Foreign Application Priority Data
Jul. 17, 2024 (JP) 2024-113781

(51) Int. Cl. H04L 9/40; H04L 9/08

(52) U.S. Cl. CPC H04L 63/0428; H04L 9/0855

(57) ABSTRACT

A secret data communications system includes at least one memory storing commands and at least one processor executing the commands. The at least one processor executes the commands to select the transmission sections of the number of encryption targets for encrypted communication from among the transmission sections of the number of divisions relevant to each of the divided data divided from the predetermined data by secret distribution processing, and causes each of a pair of communication apparatuses at both ends of the selected transmission section to perform communication in which the divided data relevant to the selected transmission section is encrypted using the encryption key shared between the pair of communication apparatuses based on the quantum key distribution. The number of encryption targets is equal to or more than the minimum number of pieces of divided data for restoration to predetermined data and less than the number of divisions.

### INCORPORATION BY REFERENCE

This application is based upon and claims the benefit of priority from Japanese patent application No. 2024-113781, filed on Jul. 17, 2024, the disclosure of which is incorporated herein in its entirety by reference.

### TECHNICAL FIELD

The present disclosure relates to a secret data communication system, a secret data communication control method, and a non-transitory computer-readable medium.

### BACKGROUND ART

As a technique for performing transmission while maintaining confidentiality of secret information, there is a secret distribution method. For example, it is assumed that secret information is transmitted from a dealer X to the dealer Y via a plurality of participants (share folders). In this case, the dealer X on a transmission side divides the secret information into n (n is a natural number equal to or more than 3.) pieces of divided data by using a (k, n)-threshold-type secret distribution method, and transmits different pieces of divided data one by one to each of the n participants. Then, each participant stores the received divided data. The dealer Y on a reception side receives the divided data from each participant, and restores the secret information from the plurality of pieces of received divided data.

Here, in the (k, n)-threshold-type secret distribution method, the secret information is divided in such a way that the secret information cannot be restored to the original secret information unless at least k (k is a natural number equal to or more than 2 and less than n.) pieces of any divided data as thresholds among the n pieces of divided data are used. JP 2004-032521 A discloses an application example of a threshold encryption scheme ((k, n)-threshold-type secret distribution method) as a secret distribution method.

Quantum cryptographic communication has attracted attention as a system for encrypting and communicating data. In quantum cryptographic communication, an encryption key is shared between a transmission apparatus and a reception apparatus by quantum key distribution (QKD) in advance, and data is encrypted by one time pad (OTP) using the shared encryption key (common key) and communicated. For example, a transmission apparatus of the dealer X and each of all n reception apparatuses in total of participants share a common key different for each participant by quantum key distribution in advance. Thereafter, between the dealer and each participant, the transmission apparatus transmits, to the reception apparatus, data obtained by encrypting the divided data by the one time pad using the common key with a specific reception apparatus. Then, the reception apparatus decrypts the encrypted data received from the transmission apparatus by the one time pad using the common key with the transmission apparatus.

### SUMMARY

However, in a case where communication is performed by encrypting all the divided data in the secret distribution method using an encryption key (common key) shared by quantum key distribution, there is a problem that a large amount of encryption keys are consumed in order to protect one piece of secret information. This is because the number of divisions of the encryption key shared by quantum key distribution is consumed by the one time pad each time divided data of one piece of secret information is encrypted or decrypted.

In view of the above-described problems, an example object of the present disclosure is to provide a secret data communication system, a secret data communication control apparatus, a method, and a program for suppressing consumption of an encryption key shared by quantum key distribution while ensuring certain safety in transmission of secret information by the secret distribution method.

A secret data communication system according to an example aspect of the present disclosure includes:
a selection means for selecting transmission sections of the number of encryption targets for encrypted communication from among transmission sections of a number of divisions relevant to each of divided data divided by secret distribution processing from predetermined data; and
an encrypted communication means for causing each of a pair of communication apparatuses at both ends of the selected transmission section to perform communication in which divided data relevant to the selected transmission section is encrypted using an encryption key shared between the pair of communication apparatuses based on quantum key distribution,
in which the number of encryption targets is equal to or more than a minimum number of the divided data to be restored to the predetermined data and less than the number of divisions.

A secret data communication control apparatus according to an example aspect of the present disclosure includes:
a selection means for selecting transmission sections of the number of encryption targets for encrypted communication from among transmission sections of a number of divisions relevant to each of divided data divided by secret distribution processing from predetermined data; and
an encrypted communication means for causing each of a pair of communication apparatuses at both ends of the selected transmission section to perform communication in which divided data relevant to the selected transmission section is encrypted using an encryption key shared between the pair of communication apparatuses based on quantum key distribution,
in which the number of encryption targets is equal to or more than a minimum number of the divided data to be restored to the predetermined data and less than the number of divisions.

A secret data communication control method according to an example aspect of the present disclosure causes a computer to execute:
selecting transmission sections of the number of encryption targets for encrypted communication from among transmission sections of a number of divisions relevant to each of divided data divided by secret distribution processing from predetermined data; and
causing each of a pair of communication apparatuses at both ends of the selected transmission section to perform communication in which divided data relevant to the selected transmission section is encrypted using an encryption key shared between the pair of communication apparatuses based on quantum key distribution,
in which the number of encryption targets is equal to or more than a minimum number of the divided data to be restored to the predetermined data and less than the number of divisions.

A secret data communication control program according to an example aspect of the present disclosure causes a computer to execute:
selection processing of selecting transmission sections of the number of encryption targets for encrypted communication from among transmission sections of a number of divisions relevant to each of divided data divided by secret distribution processing from predetermined data; and
encrypted communication control processing of causing each of a pair of communication apparatuses at both ends of the selected transmission section to perform communication in which divided data relevant to the selected transmission section is encrypted using an encryption key shared between the pair of communication apparatuses based on quantum key distribution,
in which the number of encryption targets is equal to or more than a minimum number of the divided data to be restored to the predetermined data and less than the number of divisions.

An example of an effect of the present disclosure is that consumption of an encryption key shared by quantum key distribution can be suppressed while securing certain safety in transmission of secret information by the secret distribution method.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating a configuration of a secret data communication system according to the present disclosure;

FIG. 2 is a flowchart illustrating a flow of a secret data communication method according to the present disclosure;

FIG. 3 is a block diagram illustrating an overall configuration of a secret data communication system according to the present disclosure;

FIG. 4 is a diagram for explaining a concept of quantum key distribution and key relay according to the present disclosure;

FIG. 5 is a diagram for explaining a relationship among a transaction apparatus, a distributed management apparatus, and a QKD platform according to the present disclosure;

FIG. 6 is a diagram for explaining a relationship between an internal configuration of a transmission path protection unit and a QKD platform according to the present disclosure;

FIG. 7 is a block diagram illustrating a configuration of a key management server according to the present disclosure;

FIG. 8 is a flowchart illustrating a flow of selection processing of an encryption target according to the present disclosure;

FIG. 9 is a diagram for explaining an example of a connection relationship of each site including a dealer and participants in the QKDN according to the present disclosure;

FIG. 10 is a diagram illustrating an example of a delivery route candidate list of a transmission section of a dealer and each participant according to the present disclosure;

FIG. 11 is a diagram illustrating a selection example of an optimal delivery route of a transmission section of a dealer and each participant according to the present disclosure;

FIG. 12 is a diagram illustrating an example of a transmission section of an encryption target selected based on the number of hops according to the present disclosure;

FIG. 13 is a flowchart illustrating a flow of processing of a transmission path protection unit at a transmission site according to the present disclosure;

FIG. 14 is a flowchart illustrating a flow of processing of a transmission path protection unit at a reception site according to the present disclosure; and

FIG. 15 is a block diagram illustrating a hardware configuration of the secret data communication control apparatus according to the present disclosure.

### EXAMPLE EMBODIMENT

Hereinafter, example embodiments of the present disclosure will be described in detail with reference to the drawings. In the drawings, the same or correspondent elements are denoted by the same reference numerals, and repeated description thereof will be omitted as necessary to clarify description.

### First Example Embodiment

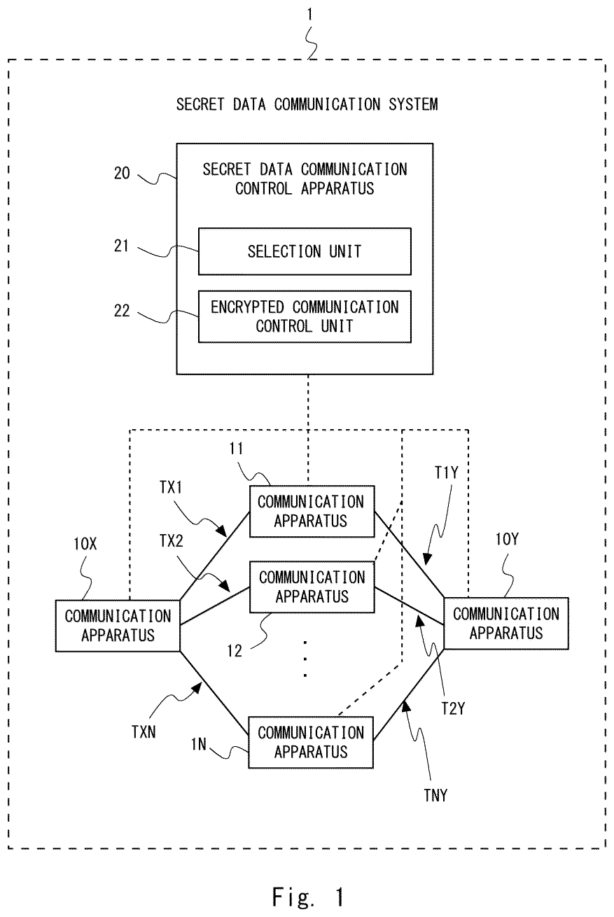

FIG. 1 is a block diagram illustrating a configuration of a secret data communication system 1. The secret data communication system 1 includes communication apparatuses 10X, 10Y, and 11 to 1N (N is a natural number equal to or more than 3.) and a secret data communication control apparatus 20. The secret data communication system 1 is an information system for communicating predetermined data as secret data between the communication apparatus 10X and the communication apparatus 10Y. Here, the communication apparatus 10X is connected to each of the N communication apparatuses 11, 12, . . . , 1N via a transmission path (communication line). The communication apparatus 10Y is connected to each of the N communication apparatuses 11, 12, . . . , 1N via a transmission path. That is, the communication apparatus 10X and the communication apparatuses 11 to 1N can be called N different transmission sections TX1, TX2, . . . , TXN. For example, both ends of the transmission section TX1 are a pair of communication apparatuses 10X and the communication apparatus 11. Similarly, both ends of the transmission section TX2 are a pair of communication apparatuses 10X and the communication apparatus 12. Both ends of the transmission section TXN are a pair of communication apparatuses 10X and the communication apparatus 1N. It can be said that N different transmission sections T1Y, T2Y, . . . , TNY are provided between each of the communication apparatuses 11 to 1N and the communication apparatus 10Y. In each transmission section, transmission paths or communication apparatuses passing through may partially overlap.

As a premise, it is assumed that an encryption key shared between the pair of communication apparatuses based on quantum key distribution is stored in advance in each of the pair of communication apparatuses at both ends of each transmission section.

The secret data communication control apparatus 20 is connected to each of the communication apparatuses 10X, 10Y, and 11 to 1N so as to be able to control encrypted communication. The secret data communication control apparatus 20 controls secret data communication in the transmission sections TX1 to TXN between the communication apparatus 10X and the communication apparatuses 11 to 1N and the transmission sections T1Y to TNY between the communication apparatuses 11 to 1N and the communication apparatus 10Y. The secret data communication control apparatus 20 is achieved by one or more computer apparatuses. The secret data communication control apparatus 20 includes a selection unit 21 and an encrypted communication control unit 22.

The selection unit 21 selects the transmission sections of the number of encryption targets for encrypted communication from among the transmission sections of the number of divisions relevant to each of the divided data divided by the secret distribution processing from the predetermined data. Here, the predetermined data may be referred to as secret information or secret data. The predetermined data is data to be concealed according to the present disclosure. The “secret distribution processing” includes, for example, data division processing using the (k, n)-threshold-type secret distribution method described above. Therefore, n is a “number of divisions” and is a natural number equal to or more than 3. In the following description, n and N are the same value. However, N may be equal to or more than n. k is a threshold and is a natural number equal to or more than 2 and less than n. In the (k, n)-threshold-type secret distribution method, even if less than k pieces of divided data are intercepted during transmission, it is assumed that the data cannot be restored to the original data. That is, the predetermined data can be restored to the original data by k or more pieces of divided data. The “number of encryption targets” is equal to or more than the minimum number (k) of divided data to be restored to the predetermined data of the division source and less than the number (n) of divisions. The “minimum number (k) of pieces of divided data to be restored to the predetermined data of the division source” may be larger than half (n/2) of the number of divisions. As a result, the security can be reliably ensured by encrypting the minimum number k of pieces of divided data by the (k, n)-threshold-type secret distribution method.

For example, the communication apparatus 10X divides the predetermined data into the N pieces of divided data DX1 to DXN by the secret distribution processing. Then, the communication apparatus 10X transmits each divided data to each of the N different communication apparatuses 11 to 1N in different transmission sections TX1 to TXN. For example, the communication apparatus 10X transmits the divided data DX1 to the communication apparatus 11 in the transmission section TX1. Similarly, the communication apparatus 10X transmits the divided data DX2 to the communication apparatus 12 in the transmission section TX2. The communication apparatus 10X transmits the divided data DXN to the communication apparatus 1N in the transmission section TXN. The communication apparatus 10Y receives each divided data in different transmission sections T1Y to TNY from each of the N communication apparatuses 11 to 1N. For example, the communication apparatus 10Y receives the divided data DX1 from the communication apparatus 11 in the transmission section T1Y. Similarly, the communication apparatus 10X transmits the divided data DX2 to the communication apparatus 12 in the transmission section TX2. The communication apparatus 10X transmits the divided data DXN to the communication apparatus 1N in the transmission section TXN.

The encrypted communication control unit 22 causes each of the pair of communication apparatuses at both ends of the selected transmission section to perform communication in which the divided data relevant to the selected transmission section is encrypted using the encryption key shared between the pair of communication apparatuses based on quantum key distribution. For example, in a case where the transmission section TX1 is selected by the selection unit 21, the encrypted communication control unit 22 causes each of the communication apparatuses 10X and 11 at both ends of the transmission section TX1 to perform communication in which the divided data DX1 relevant to the transmission section TX1 is encrypted using an encryption key shared in advance between the communication apparatuses 10X and 11 based on quantum key distribution. Therefore, under the control of the encrypted communication control unit 22, the communication apparatus 10X transmits the encrypted data obtained by encrypting the divided data DX1 by the one time pad using the encryption key shared based on the quantum key distribution to the communication apparatus 11. Under the control of the encrypted communication control unit 22, the communication apparatus 11 decrypts the received data from the communication apparatus 10X by the one time pad using the encryption key shared based on the quantum key distribution, and acquires the divided data DX1.

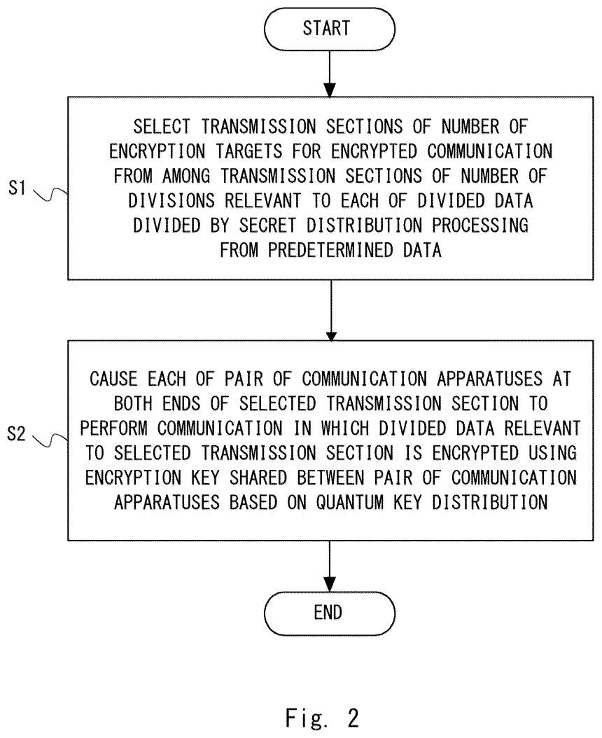

FIG. 2 is a flowchart illustrating a flow of a secret data communication method. First, the selection unit 21 selects the transmission sections of the number of encryption targets for encrypted communication from among the transmission sections of the number of divisions relevant to each of the divided data divided by the secret distribution processing from the predetermined data (S1). Here, the number of encryption targets is equal to or more than the minimum number of pieces of divided data for restoration to predetermined data of the division source and less than the number of divisions.

Next, the encrypted communication control unit 22 causes each of the pair of communication apparatuses at both ends of the selected transmission section to perform communication in which the divided data relevant to the selected transmission section is encrypted using the encryption key shared between the pair of communication apparatuses based on quantum key distribution (S2).

As described above, according to the present example embodiment, at least the number of consumed encryption keys can be suppressed as compared with a case where all (n) pieces of divided data are encrypted and transmitted on the one time pad by using an encryption key shared based on quantum key distribution. This is because the number of pieces of divided data of the encryption target is equal to or more than the minimum number of pieces of divided data for restoration to predetermined data as a division source and less than the number of divisions. That is, this is because encrypted communication is performed by the one time pad using the encryption key shared based on quantum key distribution not in all the transmission sections but in the transmission sections of the number of encryption targets. Therefore, it is possible to suppress consumption of an encryption key shared by quantum key distribution while securing certain safety in transmission of secret information by the secret distribution method.

The secret data communication control apparatus 20 includes a processor, a memory, and a storage device as components not illustrated. The storage device stores, for example, a computer program in which processing of a secret data communication control method of FIG. 2 is implemented. Then, the processor reads the computer program or the like from the storage device into the memory and executes the computer program. As a result, the processor implements the functions of the selection unit 21 and the encrypted communication control unit 22.

Alternatively, each component of the secret data communication control apparatus 20 may be implemented by dedicated hardware. Some or all of the components of each apparatus may be implemented by a general-purpose or dedicated circuitry, a processor, or a combination thereof. These components may be configured with a single chip or may be configured with a plurality of chips connected via a bus. Some or all of the components of each apparatus may be implemented by a combination of the above circuit or the like and a program. As the processor, a central processing unit (CPU), a graphics processing unit (GPU), a field-programmable gate array (FPGA), a quantum processor (quantum computer control chip), or the like may be used.

In a case where some or all of the components of the secret data communication control apparatus 20 are implemented by a plurality of information processing apparatuses, circuits, and the like, the plurality of information processing apparatuses, circuits, and the like may be arranged in a centralized manner or in a distributed manner. For example, the information processing apparatuses, the circuits, or the like may be implemented in the form of a client server system, a cloud computing system, or the like in which they are connected to each other through a communication network. The function of the secret data communication control apparatus 20 may be provided in a software as a service (SaaS) format.

### Second Example Embodiment

Here, if an encryption key is shared between a pair of communication apparatuses at both ends of a certain transmission section based on quantum key distribution, in a case where the distance of the transmission section is a certain distance or more, there is a case where the encryption key cannot be shared only by the quantum key distribution due to physical restriction. Therefore, key relay is used to share an encryption key based on quantum key distribution between a pair of communication apparatuses in a transmission section of a certain distance or more. The key relay is a technology of relaying one or more communication apparatuses (relay apparatus, site) between both ends of a transmission section and transmitting an encryption key to be shared by encrypted communication. Here, the communication apparatus and the relay apparatus are referred to as a trusted office building (Trusted Node, site). Then, in the key relay, in the transmission of the encryption key itself between one end of the transmission section and the relay apparatus or between the relay apparatuses, the encryption key shared in advance between the apparatuses based on quantum key distribution is used and transmitted by encrypted communication using the one time pad. Therefore, the key relay also consumes the shared encryption key based on quantum key distribution (with the relay apparatus). The technology according to the present disclosure can also solve such problems. An example thereof will be described below.

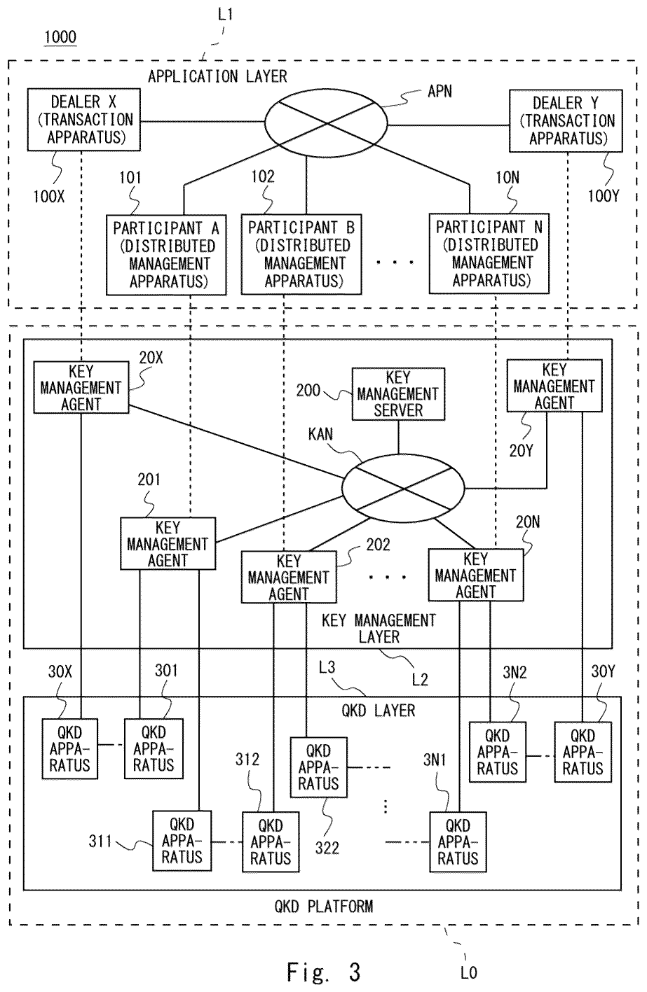

FIG. 3 is a block diagram illustrating an overall configuration of a secret data communication system 1000. The secret data communication system 1000 is an example of the secret data communication system 1 described above. The secret data communication system 1000 is an information system that uses secret distribution processing and partial quantum cryptographic communication in a case where the dealer X transmits secret information that is predetermined data to the dealer Y via the participants A to N. The participants A to N are entities that participate in (temporary) storage of divided data (share) in the secret distribution processing.

The secret data communication system 1000 includes an application layer L1, a key management layer L2, and a quantum key distribution (QKD) layer L3. The key management layer L2 and the QKD layer L3 are included in a QKD platform LO. The application layer L1 includes a transaction apparatus 100X on the dealer X side, a transaction apparatus 100Y on the dealer Y side, and distributed management apparatuses 101, 102, . . . , and 10N on the N participants A, B, . . . . N side. Each of the transaction apparatuses 100X and 100Y and the distributed management apparatuses 101, 102, . . . 10N is communicably connected via an application network APN. Here, the application network APN is a wired or wireless or wired and wireless communication network. The application network APN may be, for example, the Internet or a line network of a dedicated line.

The transaction apparatus 100X is an information processing apparatus or an information processing system used by the dealer X side to trade secret information. The transaction apparatus 100Y is an information processing apparatus or an information processing system used by the dealer Y side to trade secret information. In the following description, a case where the dealer X transmits the secret information to the dealer Y will be described. That is, functions related to secret distribution processing of secret information from the transaction apparatus 100X to the transaction apparatus 100Y and communication by partial quantum cryptographic communication will be described. However, the configurations of the transaction apparatuses 100X and 100Y may have equivalent functions.

Each of the distributed management apparatuses 101 to 10N is an information processing apparatus or an information processing system used by each of the participants A to N. The configuration and processing of the distributed management apparatus 101 will be described later. Each of the transaction apparatuses 100X and 100Y and the distributed management apparatuses 101 to 10N is assumed to be installed in a physically separated base.

The key management layer L2 includes a key management server 200 and key management agents 20X, 20Y, 201, 202, . . . 20N. Each of the key management server 200 and the key management agents 20X, 20Y, 201, 202, . . . 20N is communicably connected via a key management network KAN. Here, the key management network KAN is a wired or wireless or wired and wireless communication network. The key management network KAN may be, for example, the Internet or a line network of a dedicated line.

The key management server 200 is an example of the secret data communication control apparatus 20 described above. The key management server 200 is a computer apparatus that manages an encryption key used for quantum cryptographic communication. Specifically, the key management server 200 performs management of quantum key distribution and key relay, management of the accumulation amount of (unused) encryption keys generated in the QKD layer L3, selection of transmission sections used for transmission of the number of shares to be encrypted among the N shares in the application layer L1, and the like. The key management server 200 may be achieved as a computer system in which functions are distributed or redundant by a plurality of computer apparatuses. Details of the configuration of the key management server 200 will be described later.

Each of the key management agents 20X, 20Y, 201, 202, . . . 20N accumulates the encryption key generated and quantum-key-distributed in the QKD layer L3, performs key relay that is encrypted communication using another encryption key to share an encryption key for encrypted communication of the divided data as appropriate, and supplies the encryption key for encrypted communication of the divided data to the application layer L1. Each of the key management agents 20X, 20Y, 201, 202, . . . 20N is communicably connected to each of the transaction apparatuses 100X and 100Y and the distributed management apparatuses 101, 102, . . . 10N of the application layer L1. Each of the key management agent 20X and the like is an information processing apparatus or an information processing system installed in a physically separated base. The key management agent 20X and the like may be a software module that operates in a relevant device of the application layer L1. Details of the configuration of the key management agent 20X and the like will be described later.

The QKD layer L3 includes QKD apparatuses 30X, 301, 302, 311, 312, 322, . . . 3N1, 3N2, and 30Y. Each of the QKD apparatus 30X and the like is communicably connected to any one of the key management agent 20X and the like of the key management layer L2. For example, the QKD apparatus 30X is connected to the key management agent 20X, the QKD apparatuses 301 and 311 are connected to the key management agent 201, and the QKD apparatuses 312 and 322 are connected to the key management agent 202. Similarly, the QKD apparatuses 3N1 and 3N2 are connected to the key management agent 20N, and the QKD apparatus 30Y is connected to the key management agent 20Y. However, the QKD apparatus 30X and the like are not limited to hardware, and may be implemented by a software module and hardware operating in cooperation. The QKD apparatus 30X and the like are not necessarily connected to the key management agent 20X and the like on a one-to-one basis. That is, the key management agent may be connected to three or more QKD apparatuses. The QKD apparatus 30X and the like have equivalent functions. The QKD apparatus 30X and the like generate an intrinsic random number having a predetermined length as an encryption key, and supplies the encryption key to the connected key management agent 20X and the like. Adjacent (facing) QKD apparatuses in the QKD layer L3 are connected by a dedicated optical fiber. Here, it is assumed that a transmission loss of the optical fiber is allowable between the facing QKD apparatuses. Then, one of the facing QKD apparatuses transmits an encryption key, which is a common key between the key management agents relevant to the QKD apparatuses, to another QKD apparatus through quantum cryptographic communication via an optical fiber. A common key between the key management agents is used in key relay.

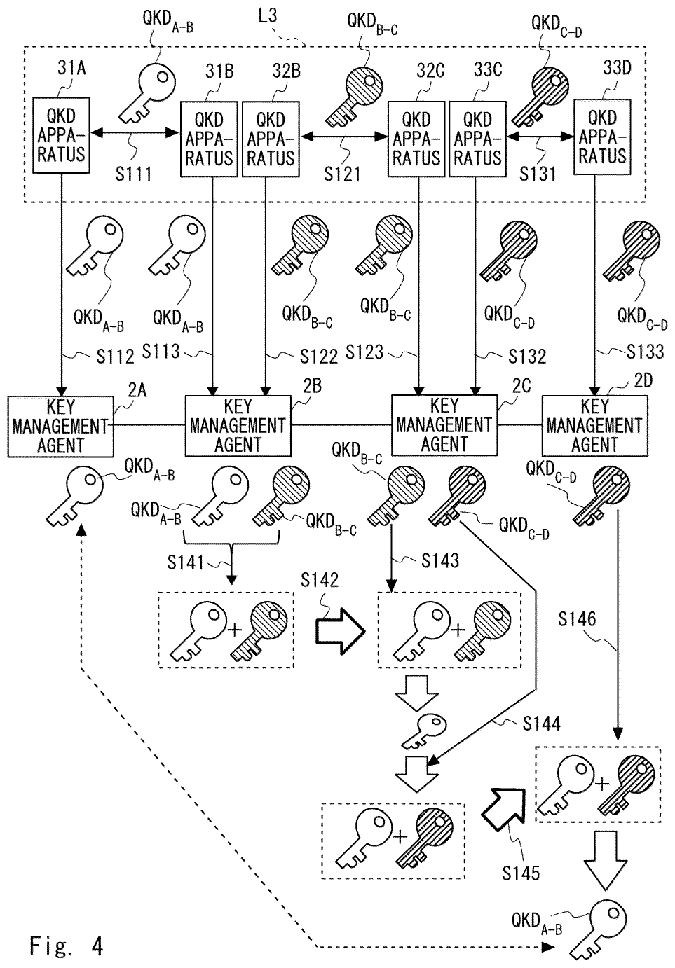

FIG. 4 is a diagram for explaining a concept of quantum key distribution and key relay. Here, a case where a key QKD_{A-B} held by a key management agent 2A is shared with a key management agent 2D via two hops on the delivery route in the key relay of the encryption key for sharing based on quantum key distribution will be described. As a premise, QKD apparatuses 31A and 31B are connected by an optical fiber as described above. The same applies between QKD apparatuses 32B and 32C and between QKD apparatuses 33C and 33D. That is, it is assumed that the key QKD_{A-B} cannot be directly transmitted from the QKD apparatus 31A to the QKD apparatus 33D due to physical restriction such as transmission loss by quantum key distribution via an optical fiber.

Therefore, first, one of the QKD apparatus 31A or 31B generates the key QKD_{A-B} of an intrinsic random number, and transmits the key QKD_{A-B} to the another QKD apparatus by quantum cryptographic communication via an optical fiber (S111). For example, in a case where the QKD apparatus 31A generates the key QKD_{A-B}, the QKD apparatus 31A regards the key QKD_{A-B} as data, and transmits information of 1 bit (one photon) for each photon on an optical fiber (quantum channel) to the QKD apparatus 31B. Then, the QKD apparatuses 31A and 31B share the key extraction information via the classical channel. As a result, it is possible to verify whether the key QKD_{A-B} is accurately and safely transmitted from the QKD apparatus 31A to the QKD apparatus 31B. If an eavesdropper intercepts a 1-bit photon in the quantum channel, the photon does not reach the QKD apparatus 31B on a reception side. In a case where an eavesdropper returns a 1-bit photon to the quantum channel, the state of the photon changes quantum mechanically. Therefore, in any case, the QKD apparatuses 31A and 31B can detect eavesdropping by key extraction information or the like, discard key data transmitted and received by both apparatuses, and separately attempt to generate and share a new key. As a result, it is possible to share a secure encryption key between facing QKD apparatuses connected by an optical fiber at a predetermined distance.

Then, the QKD apparatus 31A supplies the key QKD_{A-B} shared with the QKD apparatus 31B to the relevant key management agent 2A (S112). As a result, the key management agent 2A holds the key QKD_{A-B} as a common key shared with a key management agent 2B. Similarly, the QKD apparatus 31B supplies the key QKD_{A-B} shared with the QKD apparatus 31A to the relevant key management agent 2B (S113). As a result, the key management agent 2B holds the key QKD_{A-B} as a common key shared with the key management agent 2A.

Thereafter, similarly, the key QKD_{B-C} is shared between the QKD apparatuses 32B and 32C (S121). Then, the QKD apparatus 32B supplies the key QKD_{B-C} to the relevant key management agent 2B (S122). The QKD apparatus 32C supplies the key QKD_{B-C} to a relevant key management agent 2C (S123). As a result, the key management agent 2B holds the key QKD_{B-C} as a common key shared with the key management agent 2C. That is, the key management agent 2B holds the key QKD_{A-B} and the key QKD_{B-C} as common keys having different sharing destinations. The key management agent 2C holds the key QKD_{B-C} as a common key shared with the key management agent 2B.

Similarly, the QKD apparatuses 33C and 33D share the key QKD_{C-D} (S131). Then, the QKD apparatus 33C supplies the key QKD_{C-D} to the relevant key management agent 2C (S132). The QKD apparatus 33D supplies the key QKD_{C-D} to the relevant key management agent 2D (S133). As a result, the key management agent 2C holds the key QKD_{C-D} as a common key shared with the key management agent 2D. That is, the key management agent 2C holds the key QKD_{B-C} and the key QKD_{C-D} as common keys having different sharing destinations. The key management agent 2D holds the key QKD_{C-D} as a common key shared with the key management agent 2C.

Thereafter, the key management agent 2A shares the key QKD_{A-B} with the key management agent 2D by the key relay. Specifically, for example, the key management agent 2B may receive, from the key management server 200, an instruction of key relay to the key management agent 2C for the key QKD_{A-B} that is a common key with the key management agent 2A. In this case, the key management agent 2B encrypts the key QKD_{A-B} by the one time pad using the key QKD_{B-C} that is a common key with the key management agent 2C (S142), and transmits encrypted data to the key management agent 2C (S142). At this time, the key management agent 2B discards the key QKD_{B-C} used in the one time pad.

Then, the key management agent 2C decrypts the encrypted data received from the key management agent 2B with the key QKD_{B-C} that is a common key with the key management agent 2B (S143), and acquires the key QKD_{A-B}. At this time, the key management agent 2C discards the key QKD_{B-C} used in the one time pad.

Subsequently, the key management agent 2C may receive, from the key management server 200, an instruction of key relay to the key management agent 2D for the key QKD_{A-B} that is a common key with the key management agent 2A. In this case, the key management agent 2C encrypts the key QKD_{A-B} decrypted in step S143 by the one time pad using the key QKD_{C-D} that is a common key with the key management agent 2D (S144), and transmits encrypted data to the key management agent 2D (S145). At this time, the key management agent 2C discards the key QKD_{C-D} used in the one time pad. Then, the key management agent 2D decrypts the encrypted data received from the key management agent 2C with the key QKD_{C-D} that is a common key with the key management agent 2C (S146), and acquires the key QKD_{A-B}. At this time, the key management agent 2D discards the key QKD_{C-D} used in the one time pad.

In this manner, the key management agents 2A and 2D can share the key QKD_{A-B} by quantum key distribution and key relay. Then, in this example, two keys QKD_{B-C} and QKD_{C-D} generated by the QKD apparatus are consumed by passing through two hops on the delivery route in the key relay.

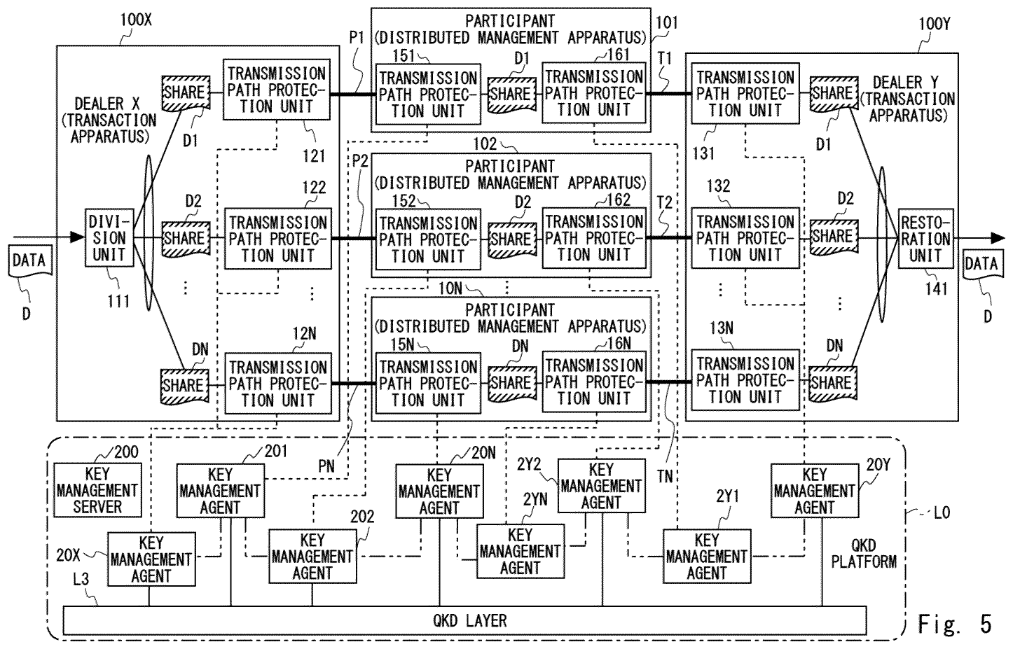

FIG. 5 is a diagram for explaining a relationship among the transaction apparatuses 100X and 100Y, the distributed management apparatuses 101 to 10N, and the QKD platform LO. The transaction apparatus 100X includes at least a division unit 111 and transmission path protection units 121, 122, . . . 12N. The transaction apparatus 100Y includes at least transmission path protection units 131, 132, . . . 13N, and a restoration unit 141. The distributed management apparatus 101 includes at least transmission path protection units 151 and 161 and a storage unit (not illustrated) of a share D1. The distributed management apparatus 102 includes at least transmission path protection units 152 and 162 and a storage unit (not illustrated) of a share D2. Thereafter, similarly, the distributed management apparatus 10N includes at least transmission path protection units 15N and 16N and a storage unit (not illustrated) of a share DN. The above-described “division unit”, “transmission path protection unit”, and “restoration unit” are functional blocks, and may be achieved by a software module.

Here, the transmission path protection unit 121 and the transmission path protection unit 151 are connected by a transmission path P1. Therefore, the transaction apparatus 100X including the transmission path protection unit 121 and the distributed management apparatus 101 including the transmission path protection unit 151 can be referred to as a pair of communication apparatuses at both ends of the transmission section relevant to the share DI. Similarly, the transmission path protection unit 161 and the transmission path protection unit 131 are connected by a transmission path T1. Therefore, the distributed management apparatus 101 including the transmission path protection unit 161 and the transaction apparatus 100Y including the transmission path protection unit 131 can be referred to as a pair of communication apparatuses at both ends of the transmission section relevant to the share D1.

The transmission path protection unit 122 and the transmission path protection unit 152 are connected by a transmission path P2. The transmission path protection unit 162 and the transmission path protection unit 132 are connected by a transmission path T2. Therefore, a pair of communication apparatuses at both ends of the transmission section relevant to the share D2 is a pair of the transaction apparatus 100X and the distributed management apparatus 102, and is also a pair of the distributed management apparatus 102 and the transaction apparatus 100Y.

Thereafter, similarly, the transmission path protection unit 12N and the transmission path protection unit 15N are connected by a transmission path PN. The transmission path protection unit 16N and the transmission path protection unit 13N are connected by a transmission path TN. Therefore, a pair of communication apparatuses at both ends of the transmission section relevant to the share DN is a pair of the transaction apparatus 100X and the distributed management apparatus 10N, and is also a pair of the distributed management apparatus 10N and the transaction apparatus 100Y.

The QKD platform LO is equivalent to FIG. 3 described above. FIG. 5 illustrates an example in which the key management agents 20X, 201, 202, 20N, 2YN, 2Y2, 2Y1, and 20Y are connected in series. However, as described above with reference to FIG. 3, it is assumed that each key management agent and the key management server 200 are communicably connected via the application network APN.

It is assumed that the key management agent 20X is supplied with N encryption keys relevant to the encryption of the transmission sections of the transmission paths P1 to PN from the QKD layer L3. Then, the key management agent 20X shares an encryption key KP1 relevant to the transmission path P1 with the key management agent 201 by the key relay. Similarly, the key management agent 20X shares an encryption key KP2 relevant to the transmission path P2 with the key management agent 202 by the key relay. The key management agent 20X shares an encryption key KPN relevant to the transmission path PN with the key management agent 20N by the key relay. At this time, as described above, the encryption key relevant to the number of hops of the delivery route of the key relay is consumed. Then, the key management agent 20X supplies the encryption key KP1 to the transmission path protection unit 121, the encryption key KP2 to the transmission path protection unit 122, and the encryption key KPN to the transmission path protection unit 12N. The key management agent 201 supplies the encryption key KP1 to the transmission path protection unit 151. The key management agent 202 supplies the encryption key KP2 to the transmission path protection unit 152. Thereafter, similarly, the key management agent 20N supplies the encryption key KPN to the transmission path protection unit 15N.

Similarly, the key management agent 20Y assumes that N encryption keys relevant to encryption of the transmission sections of the transmission paths T1 to TN are supplied from the QKD layer L3. Then, the key management agent 20Y shares an encryption key KT1 relevant to the transmission path T1 with the key management agent 2Y1 by the key relay. Similarly, the key management agent 20Y shares an encryption key KT2 relevant to the transmission path T2 with the key management agent 2Y2 by the key relay. The key management agent 20Y shares an encryption key KTN relevant to the transmission path TN with the key management agent 2YN by the key relay. At this time, as described above, the encryption key relevant to the number of hops of the delivery route of the key relay is consumed. Then, the key management agent 20Y supplies the encryption key KT1 to the transmission path protection unit 131, the encryption key KT2 to the transmission path protection unit 132, and the encryption key KTN to the transmission path protection unit 13N. The key management agent 2Y1 supplies the encryption key KT1 to the transmission path protection unit 161. The key management agent 2Y2 supplies the encryption key KT2 to the transmission path protection unit 162. Thereafter, similarly, the key management agent 2YN supplies the encryption key KTN to the transmission path protection unit 16N.

Since the distributed management apparatus 101 or the like includes the transmission path protection units on the transaction apparatus 100X side and the transaction apparatus 100Y side, the encryption key may be supplied from the same key management agent. For example, the key management agents 201 and 2Y1 may be the same. Similarly, the key management agents 202 and 2Y2 and the key management agents 20N and 2YN may be the same.

Next, the configurations of the transaction apparatuses 100X and 100Y and the distributed management apparatuses 101 to 10N will be described. The division unit 111 of the transaction apparatus 100X acquires the transaction target data D from the outside and divides the transaction target data D into N shares D1, D2, . . . . DN by secret distribution processing. In a case where the selection result by the key management server 200 is a target of encrypted communication, the transmission path protection unit 121 encrypts the share DI using the encryption key KP1 and transmits encrypted data to the transmission path protection unit 151 via the transmission path P1. In a case where the selection result is not a target of encrypted communication, the transmission path protection unit 121 transmits the share D1 as it is to the transmission path protection unit 151 via the transmission path P1. Similarly, the transmission path protection unit 122 determines whether to use the encryption key KP2 according to the selection result, and transmits the share D2 or the encrypted data of the share D2 to the transmission path protection unit 152 via the transmission path P2. Thereafter, similarly, the transmission path protection unit 122 determines whether to use the encryption key KPN according to the selection result, and transmits the share DN or the encrypted data of the share DN to the transmission path protection unit 15N via the transmission path PN. In these cases, the encryption key is used because the selection result is a target of encrypted communication, so that each transmission path protection unit consumes, that is, discards the used encryption key.

The transmission path protection unit 151 of the distributed management apparatus 101 determines whether to use the encryption key KP1 according to whether the selection result by the key management server 200 is a target of encrypted communication for the data received from the transmission path protection unit 121 via the transmission path P1. In a case where the received data is a target of encrypted communication, the transmission path protection unit 151 decrypts the received data using the encryption key KP1 and acquires the share D1. Thereafter, similarly, the transmission path protection units 152 to 15N determine whether to use KPN from the encryption key KP2 according to the selection result, and in a case where the data is a target of encrypted communication, the relevant transmission path protection unit decrypts the received data using the encryption key and acquires the DN from the share D2.

Each of the transmission path protection units 161 to 16N of the distributed management apparatus 101 to 10N determines whether to use the encryption keys KT1 to KTN according to the selection result similarly to the transmission path protection unit 121 and the like, and in a case where the data is a target of encrypted communication, the relevant transmission path protection unit encrypts the share held by the own apparatus using the encryption key and transmits the encrypted data to the relevant transmission path protection unit via the relevant transmission path. On the other hand, in a case where the data is not a target of encrypted communication, the relevant transmission path protection unit transmits the share held by the own apparatus as it is to the relevant transmission path protection unit via the relevant transmission path. Each of the transmission path protection units 131 to 13N of the transaction apparatus 100Y determines whether to use the encryption keys KT1 to KTN according to the selection result similarly to the transmission path protection unit 151 and the like, and in a case where the data is a target of encrypted communication, the relevant transmission path protection unit decrypts the received data using the encryption key to acquire a share. On the other hand, in a case where the data is not a target of encrypted communication, the relevant transmission path protection unit acquires the received data as a share. Thereafter, the restoration unit 141 of the transaction apparatus 100Y restores the data D using the shares DI to DN acquired from the transmission path protection unit 131 to 13N. The restoration unit 141 may output the restored data D for subsequent processing.

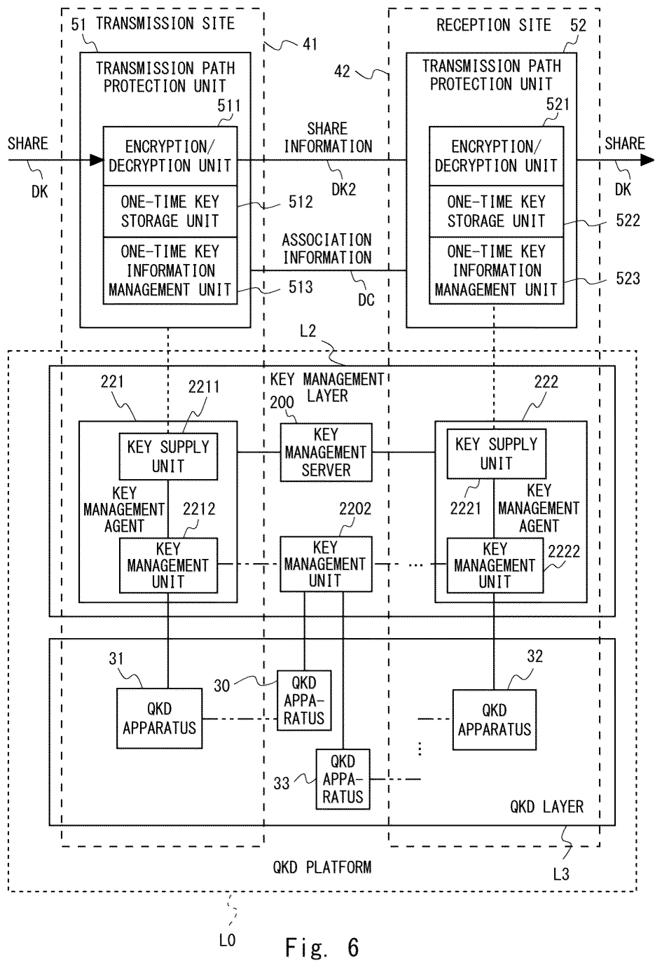

FIG. 6 is a diagram for explaining a relationship between an internal configuration of a transmission path protection unit and a QKD platform. Here, a relationship between a transmission site 41 and a reception site 42 is also illustrated. The “site” has the same physical base, and each configuration in the site is achieved by the same computer or a plurality of computers that are safely connected even if the layers are different. The transmission site 41 illustrates an example to which a transmission path protection unit 51 of the application layer L1, a key management agent 221 of the key management layer L2, and a QKD apparatus 31 of the QKD layer L3 belong. The reception site 42 illustrates an example to which a transmission path protection unit 52 of the application layer L1, a key management agent 222 of the key management layer L2, and a QKD apparatus 32 of the QKD layer L3 belong. It is assumed that the transmission site 41 and the reception site 42 need to pass through a plurality of communication apparatuses (sites) on the delivery route of key relay.

First, the QKD apparatuses 31, 30, 22, and 32 in the QKD layer L3 in the QKD platform LO have functions similar to those of the QKD apparatus described above. In this example, the QKD apparatuses 31 and 30 face each other and are connected by a dedicated optical fiber. A QKD apparatus 33 is connected to a facing QKD apparatus (not illustrated) by a dedicated optical fiber. Similarly, the QKD apparatus 32 is connected to a facing QKD apparatus (not illustrated) via a dedicated optical fiber. The QKD apparatuses 30 and 33 are assumed to be connected to the same key management unit 2202. The number of QKD apparatuses and the connection relationship are not limited thereto.

The key management layer L2 in the QKD platform LO includes the key management server 200, the key management agent 221, and the key management agent 222. The key management unit 2202 has a configuration in a key management agent (not illustrated) on the delivery route of key relay between the key management agent 221 and the key management agent 222. That is, the key management unit 2202 does not belong to at least either the transmission site 41 or the reception site 42. However, an encryption key shared with the QKD apparatus 31 (key management unit 2212) is supplied from the QKD apparatus 30, and similarly, an encryption key shared with the facing QKD apparatus is supplied from the QKD apparatus 33, and the key management unit 2202 accumulates each encryption key in an internal storage unit (not illustrated). The site to which the key management server 200 belongs is not limited.

The key management agent 221 of the transmission site 41 includes a key supply unit 2211 and a key management unit 2212. The key management unit 2212 acquires an encryption key shared with the facing QKD apparatus 31 from the QKD apparatus 30, and accumulates the acquired encryption key in an internal storage unit (not illustrated). In response to an instruction of key relay from the key management server 200, the key management unit 2212 encrypts an encryption key to be delivered among the accumulated encryption keys by the one time pad using a common key with the key management unit 2202 of the delivery destination, and transmits encrypted data to the key management unit 2202. Then, the key management unit 2212 discards the encryption key used for the one time pad. Then, the key management unit 2212 supplies the delivery target encryption key to the key supply unit 2211.

The key supply unit 2211 supplies the encryption key supplied from the key management unit 2212 to the transmission path protection unit 51 belonging to the transmission site 41. In a case where the key supply unit 2211 receives the selection result from the key management server 200, it may transmit the selection result to the transmission path protection unit 51.

The key management agent 222 of the reception site 42 includes a key supply unit 2221 and a key management unit 2222. Each configuration of the key management agent 222 is similar to that of the key management agent 221 described above. The key management unit 2222 acquires an encryption key shared with a facing QKD apparatus (not illustrated) from the QKD apparatus 32, and accumulates the acquired encryption key in an internal storage unit (not illustrated). The key management unit 2222 decrypts the encrypted data received by key relay from the adjacent key management unit using a common key with the facing QKD apparatus, and accumulates the decrypted data in the storage unit. Then, the key management unit 2222 discards the encryption key used for the one time pad. Then, the key management unit 2222 supplies the encryption key acquired by key relay to the key supply unit 2221. The key supply unit 2221 supplies the encryption key supplied from the key management unit 2222 to the transmission path protection unit 52 belonging to the reception site 42. In a case where the key supply unit 2221 receives the selection result from the key management server 200, it may transmit the selection result to the transmission path protection unit 52.

The transmission path protection unit 51 of the transmission site 41 includes an encryption/decryption unit 511, a one-time key storage unit 512, and a one-time key information management unit 513. The one-time key storage unit 512 is a storage area that stores the encryption key supplied from the key supply unit 2211 as a one-time key used in the one time pad. The one-time key information management unit 513 manages the one-time key stored in the one-time key storage unit 512. Specifically, the one-time key information management unit 513 holds information of the accumulation amount (the number of keys or the like) of the one-time key. Therefore, in a case where the encryption key supplied from the key supply unit 2211 is stored in the one-time key storage unit 512, the one-time key information management unit 513 adds 1 to the accumulation amount. On the other hand, in a case where the encryption/decryption unit 511 uses an encryption key that is a one-time key in the one time pad, the one-time key information management unit 513 deletes the used one-time key from the one-time key storage unit 512 and subtracts 1 from the accumulation amount. The one-time key information management unit 513 may transmit and receive association information DC to and from a one-time key information management unit 523 in the transmission path protection unit 52 of the reception site 42. The association information DC may be used for synchronization of the accumulation amount of the one-time key between the transmission site 41 and the reception site 42.

If the encryption/decryption unit 511 acquires a share DK, it acquires the selection result of the target of encrypted communication from the key management server 200, for example, via the key supply unit 2211. Then, the encryption/decryption unit 511 determines whether it is a target of encrypted communication from the selection result. In a case where it is a target of encrypted communication, the encryption/decryption unit 511 acquires a single one-time key from the one-time key storage unit 512, and encrypts the share DK with the one-time key to generate share information DK2. Then, the encryption/decryption unit 511 transmits the share information DK2 to the transmission path protection unit 52 via the transmission path with the transmission path protection unit 52. On the other hand, in a case where it is not a target of encrypted communication, the encryption/decryption unit 511 transmits the share information DK2 to the transmission path protection unit 52 via the transmission path with the transmission path protection unit 52, with the share DK as the share information DK2.

The transmission path protection unit 52 of the reception site 42 includes an encryption/decryption unit 521, a one-time key storage unit 522, and a one-time key information management unit 523. Since the one-time key storage unit 522 and the one-time key information management unit 523 are similar to the one-time key storage unit 512 and the one-time key information management unit 513 described above, the description thereof will be omitted.

If the encryption/decryption unit 521 receives the share information DK2 from the transmission path protection unit 51 via the transmission path, it acquires a selection result of a target of encrypted communication from the key management server 200 via, for example, the key supply unit 2221. Then, the encryption/decryption unit 521 determines whether it is a target of encrypted communication from the selection result. In a case where it is a target of encrypted communication, the encryption/decryption unit 521 acquires a single one-time key from the one-time key storage unit 522, decrypts the share information DK2 with the one-time key, and acquires the share DK. At this time, the one-time key information management unit 523 deletes the one-time key used for decryption from the one-time key storage unit 522, and subtracts 1 from the accumulation amount. On the other hand, in a case where it is not a target of encrypted communication, the encryption/decryption unit 521 sets the share information DK2 as the share DK. Then, the encryption/decryption unit 511 outputs the share DK for subsequent processing.

The communication apparatus including the transmission path protection unit 51 or 52 determines whether the transmission section in which the own apparatus is located at one end is a target of encrypted communication based on the selection result notified from the key management server 200. Then, in a case where the communication apparatus determines that it is a target of encrypted communication, the communication apparatus performs communication in which the divided data relevant to the transmission section is encrypted using the encryption key. That is, in a case where the communication apparatus determines that it is a target of encrypted communication, the communication apparatus encrypts and transmits the divided data or decrypts the received data by using an encryption key shared between the pair of communication apparatuses in the transmission section based on quantum key distribution. In a case where the communication apparatus determines that it is not a target of encrypted communication, the communication apparatus performs communication of the divided data relevant to the transmission section. That is, in a case where the communication apparatus determines that it is not a target of encrypted communication, the communication apparatus transmits and receives the divided data without using the encryption key.

Further, if determined to be a target of encrypted communication, the transmission apparatus, which is the communication apparatus on a transmission side of the transmission section, transmits the encrypted data obtained by encrypting the divided data relevant to the transmission section using the encryption key to the reception apparatus, which is the communication apparatus on a reception side of the transmission section. On the other hand, if determined not to be a target of encrypted communication, the transmission apparatus transmits the divided data relevant to the transmission section to the reception apparatus. Then, in a case where it is determined that it is a target of encrypted communication, the reception apparatus acquires the divided data obtained by decrypting the received data from the transmission apparatus using the encryption key. On the other hand, in a case where the reception apparatus determines that it is not a target of encrypted communication, the reception apparatus acquires the received data from the transmission apparatus as divided data.

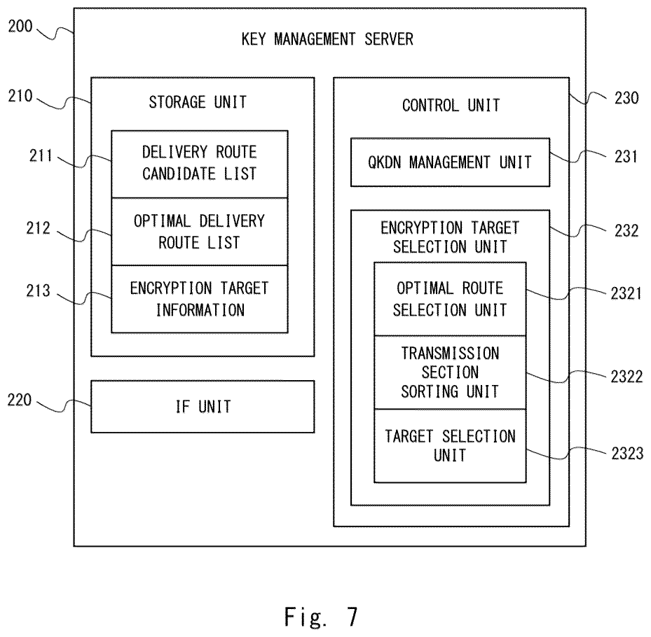

FIG. 7 is a block diagram illustrating the configuration of the key management server 200. The key management server 200 includes a storage unit 210, an interface (IF) unit 220, and a control unit 230. The storage unit 210 includes, for example, a nonvolatile storage device such as a flash memory and a memory such as a random access memory (RAM), that is, a volatile storage device. The storage unit 210 stores a delivery route candidate list 211, an optimal delivery route list 212, and encryption target information 213.

The delivery route candidate list 211 is a list of delivery route candidates that are candidates of a delivery route in the key relay for a specific transmission section. The delivery route candidate list 211 is a list for each transmission section. The delivery route candidate list 211 includes, for example, a route ID, a delivery route candidate that is the order of communication apparatuses (sites) passing through in key relay, the number of hops that is the number of communication apparatuses passing through in the delivery route candidate, a (priority) order based on a predetermined criterion of the delivery route candidate in the transmission section, and the like. However, the delivery route candidate list 211 is not limited thereto.

The optimal delivery route list 212 is a list of optimal delivery routes selected based on a predetermined criterion for each of all the transmission sections. The optimal delivery route list 212 includes a route ID, an optimal delivery route, and the number of hops selected for each transmission section. However, the optimal delivery route list 212 is not limited thereto.

The encryption target information 213 is information indicating a transmission section selected as a target of encrypted communication based on the optimal delivery route list 212. The encryption target information 213 is information relevant to the selection result of the transmission sections of the number of encryption targets. The encryption target information 213 may be expressed as an encryption target flag in the optimal delivery route list 212.

The IF unit 220 is an interface circuit that performs communication between the key management server 200 and the outside. Specifically, the IF unit 220 communicates with a key management agent or the like via the application network APN.

The control unit 230 is a control device that controls each component of the key management server 200. The control unit 230 includes a QKDN (QKD Network) management unit 231 and an encryption target selection unit 232. The QKDN management unit 231 and the encryption target selection unit 232 may be used as means for managing and selecting information or data.

The QKDN management unit 231 manages the QKD platform LO. In particular, the QKDN management unit 231 manages the accumulation amount of the encryption keys in the key management layer L2, instructs the key relay, and the like. The QKDN management unit 231 generates the delivery route candidate list 211 in the key relay for each transmission section. The QKDN management unit 231 is an example of the encrypted communication control unit 22 described above. The QKDN management unit 231 notifies each of the transmission path protection units of the selection result by the encryption target selection unit 232. The QKDN management unit 231 may notify the selection result to at least a set of transmission path protection units selected as a target of encrypted communication.

The encryption target selection unit 232 is an example of the selection unit 21 described above. The encryption target selection unit 232 selects a transmission section which is a target of encrypted communication in the application layer L1. Specifically, the encryption target selection unit 232 selects the transmission sections of the number p of encryption targets based on the delivery route of the key relay in each of the transmission sections of the number N of divisions. In this manner, by considering the delivery route in the key relay, it is possible to further suppress the number of consumed encryption keys.

Here, as in the first example embodiment, the number p of encryption targets is equal to or more than the minimum number (k) of divided data to be restored to predetermined data of a division source and less than the number (n) of divisions. Furthermore, the number p of encryption targets may be the minimum number (k) of divided data to be restored to the predetermined data of the division source. However, the number p of encryption targets is larger than half (n/2) of the number of divisions. As a result, the consumption of the encryption key in the quantum cryptographic communication can be suppressed to the minimum while reliably securing the safety.

In particular, the encryption target selection unit 232 desirably selects the transmission sections of the number p of encryption targets based on the number of hops of the delivery route. As a result, in the key relay, the encryption key is consumed by the one time pad every time hopping happens, and thus, it is possible to further suppress the number of consumed encryption keys by considering the number of hops.

The encryption target selection unit 232 includes an optimal route selection unit 2321, a transmission section sorting unit 2322, and a target selection unit 2323. The optimal route selection unit 2321, the transmission section sorting unit 2322, and the target selection unit 2323 may be used as means for selecting and sorting information or data.

For each of the transmission sections of the number N of divisions, the optimal route selection unit 2321 may select one delivery route as the optimal delivery route based on a predetermined criterion from among a plurality of delivery route candidates in the key relay. Specifically, the optimal route selection unit 2321 selects an optimal delivery route from the delivery route candidate list 211 for each transmission section based on a predetermined criterion.

Further, the optimal route selection unit 2321 may select the optimal delivery route from among the plurality of delivery route candidates, using at least one of the number of accumulated encryption keys in the communication apparatus, the number of hops in the delivery route candidate, and the communication status between the pair of communication apparatuses as a predetermined reference.

The transmission section sorting unit 2322 performs sorting in ascending order of the number of hops of the delivery routes of the selected number N of divisions. Specifically, the transmission section sorting unit 2322 sorts the transmission sections by the number of hops for the optimal delivery route list 212.

The target selection unit 2323 selects the transmission sections of the number of encryption targets based on the number of hops of the delivery routes of the selected number N of divisions. As a result, selection accuracy of an appropriate transmission section is improved. Specifically, the target selection unit 2323 may select the delivery routes relevant to the order of the number of encryption targets from the top in ascending order of the number of hops, and may select the transmission section relevant to each of the delivery routes of the selected number p of encryption targets.

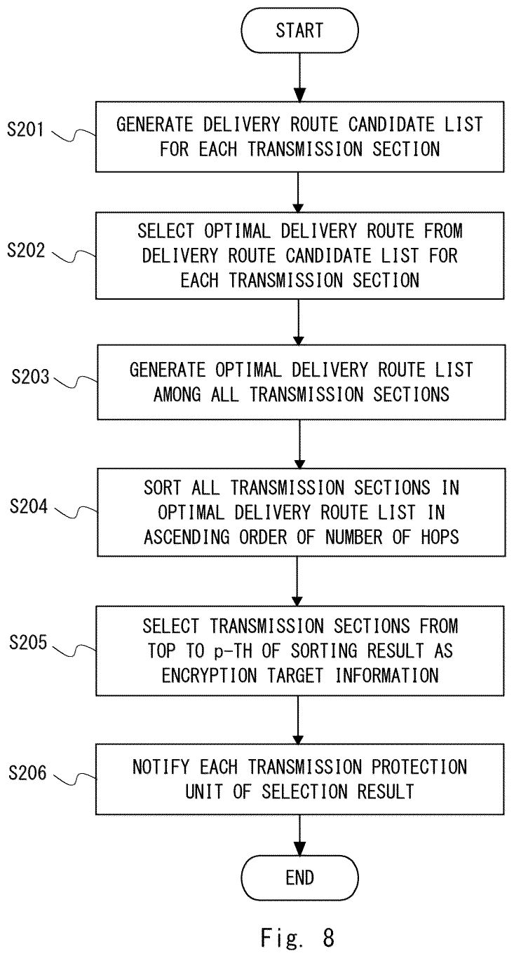

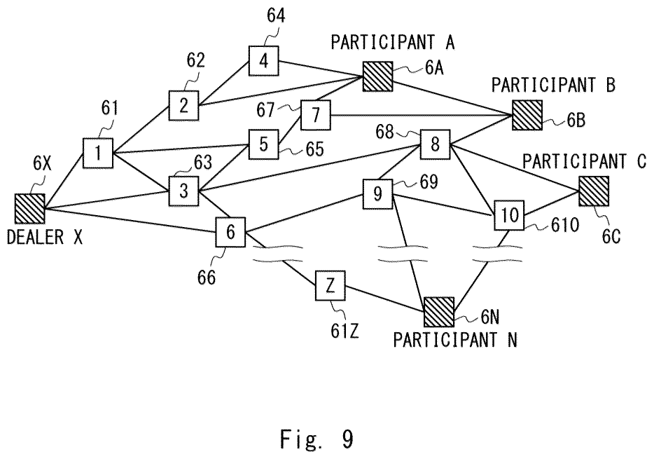

FIG. 8 is a flowchart illustrating a flow of selection processing of an encryption target. First, the QKDN management unit 231 of the key management server 200 generates a delivery route candidate list for each transmission section (S201). Here, in generating the delivery route candidate list, a connection relationship of sites will be described. FIG. 9 is a diagram for explaining an example of a connection relationship of each site including a dealer and participants in the QKDN. A site 6X is relevant to a base where the communication apparatus 10X of the dealer X exists. A site 6A is relevant to a base where the distributed management apparatus 101 of a participant A exists. A site 6B is relevant to a base where the distributed management apparatus 102 of a participant B exists. A site 6C is relevant to a base where the distributed management apparatus 103 (not illustrated) of a participant C exists. Thereafter, similarly, a site 6N is relevant to a base where the distributed management apparatus 10N of a participant N exists. Each of sites 61 to 69, 610, and 61Z is relevant to a base where there is a communication apparatus through which the key can be relayed on the quantum key distribution route. These sites may be hereinafter referred to as sites 1, 2, . . . 9, 10, and Z. It is assumed that the sites 6X, 6A, 6B, 6C, and 6N can also be bases where there is a communication apparatus through which the key can be relayed on the quantum key distribution route. FIG. 9 illustrates an example of a QKD network in which communicable sites in the key relay are connected by lines.

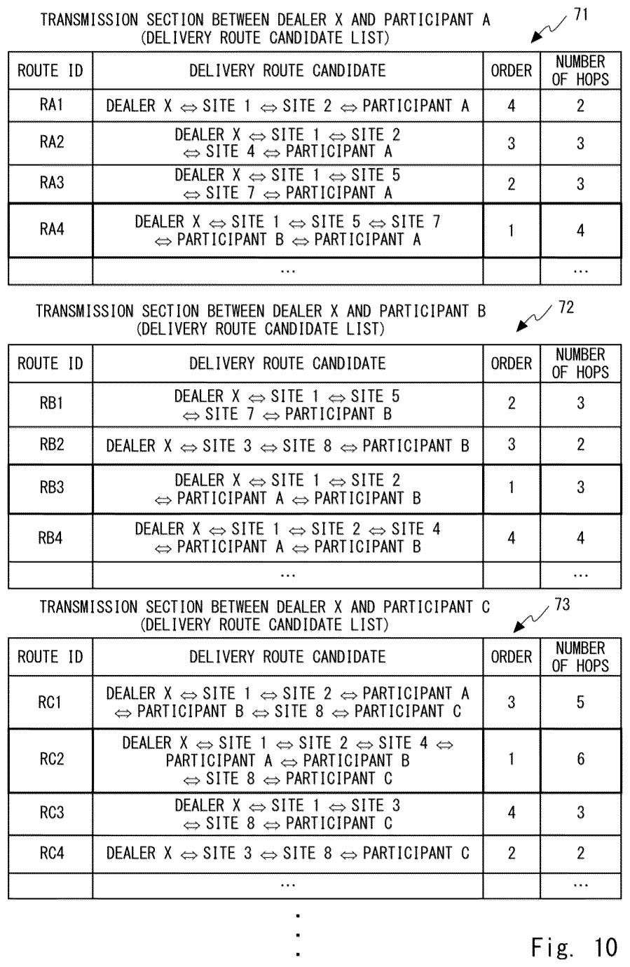

Next, the optimal route selection unit 2321 selects an optimal delivery route from the delivery route candidate list 211 for each transmission section (S202). FIG. 10 is a diagram illustrating an example of the delivery route candidate list of the transmission section of the dealer X and each participant. A delivery route candidate list 71 is an example of the delivery route candidate list in the transmission section of the dealer X and the participant A. The delivery route candidate list 71 indicates that RAI to RA4 and the like of route IDs, which are identification information of delivery route candidates, are listed. The delivery route candidate list 71 indicates, for each route ID, a delivery route candidate indicating the order of sites to specifically pass through, the number of hops of each delivery route candidate, and the priority order in the transmission section. It is assumed that the optimal route selection unit 2321 determines the priority order of the delivery route candidates based on the above-described predetermined criterion. That is, the priority order of the delivery route candidate is determined in consideration of elements other than the number of hops. The delivery route candidate list 71 indicates that the priority order of the route ID “RA4” having the number of hops of 4 is the highest.

A delivery route candidate list 72 is an example of a delivery route candidate list in the transmission section of the dealer X and the participant B. The delivery route candidate list 72 indicates that the priority order of the route ID “RB3” is the highest. A delivery route candidate list 73 is an example of the delivery route candidate list in the transmission section of the dealer X and the participant C. The delivery route candidate list 73 indicates that the priority order of the route ID “RC2” is the highest.

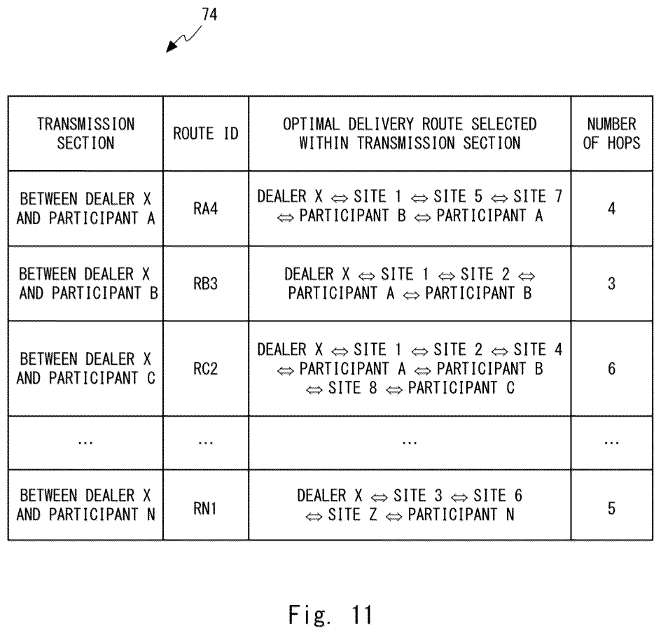

Subsequently, the optimal route selection unit 2321 generates the optimal delivery route list 212 of all the transmission sections (S203). Specifically, the optimal route selection unit 2321 selects the delivery route with the highest priority order from the delivery route candidate list of each transmission section as the optimal delivery route in the transmission section, and generates them as the optimal delivery route list 212. FIG. 11 is a diagram illustrating a selection example of the optimal delivery route of the transmission section of the dealer and each participant. An optimal delivery route list 74 indicates that the route ID “RA4” is selected in the transmission section between the dealer X and the participant A, and thereafter, one optimal delivery route is selected based on a predetermined criterion in each transmission section.

Thereafter, the transmission section sorting unit 2322 sorts all the transmission sections in the optimal delivery route list 212 in ascending order of the number of hops (S204). For example, the transmission section sorting unit 2322 sorts each transmission section of the optimal delivery route list 74 in FIG. 11 in ascending order of the number of hops.

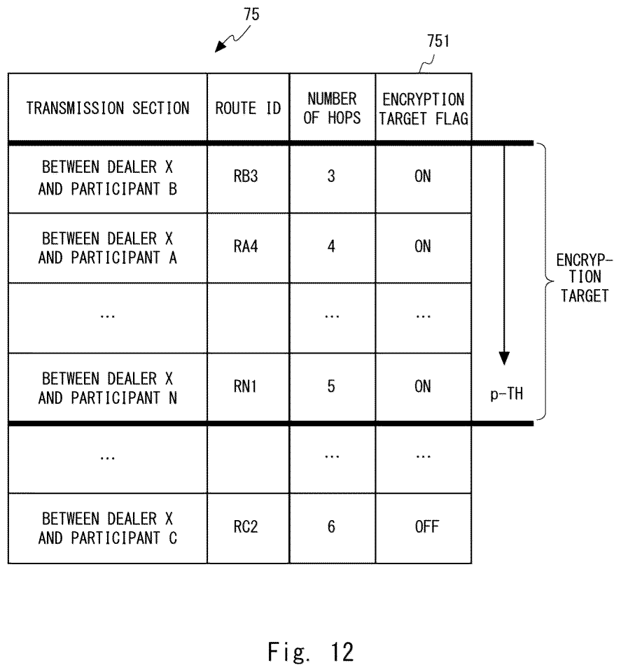

Then, the target selection unit 2323 selects the transmission sections from the top to the p-th of the sorting result as encryption target information (S205). FIG. 12 is a diagram illustrating an example of a transmission section to be encrypted selected based on the number of hops. Specifically, the target selection unit 2323 selects p route IDs “RB3”, “RA4”, . . . “RN1” as targets of encrypted communication. For example, the target selection unit 2323 sets “ON” to an encryption target flag 751 of a sorting result 75 for the selected route IDs. On the other hand, the target selection unit 2323 may set “OFF” to the encryption target flag 751 of the sorting result 75 for the route ID excluded from the target of encrypted communication.

Thereafter, the QKDN management unit 231 notifies each transmission path protection unit of the selection result in step S205 (S206).

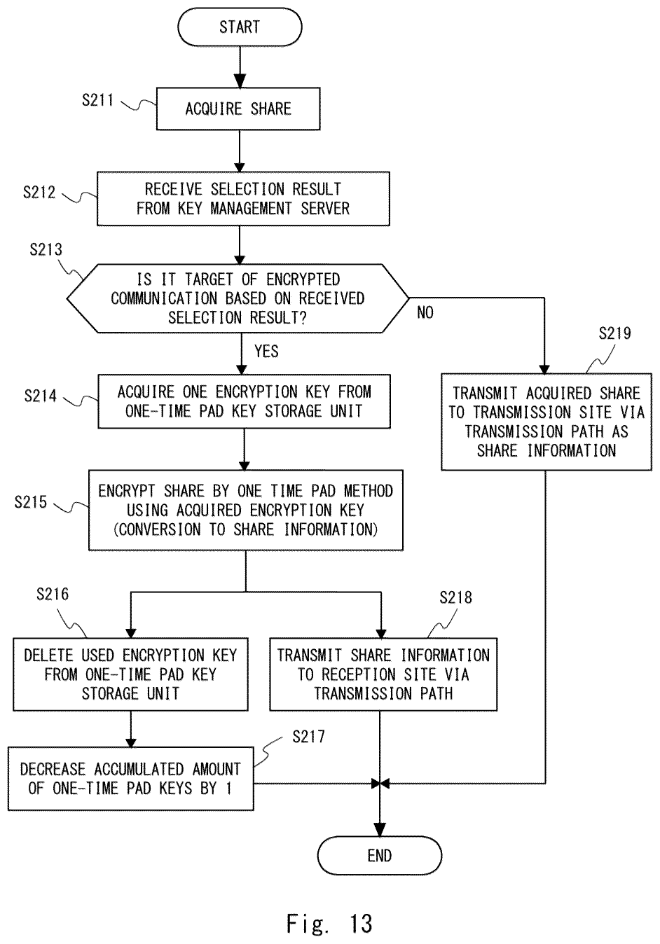

FIG. 13 is a flowchart illustrating a flow of processing of the transmission path protection unit 51 at the transmission site 41. First, the transmission path protection unit 51 acquires a share (S211). Then, the transmission path protection unit 51 receives the selection result from the key management server 200 (S212). For example, the key management server 200 may execute the selection processing of the encryption target in FIG. 8 and transmit the selection result to the transmission path protection unit 51 in step S206. Step S212 may be executed before step S211.

Subsequently, the encryption/decryption unit 511 determines whether the transmission section in which the own apparatus is present at one end is a target of encrypted communication based on the received selection result (S213). In a case where it is determined as a target of encrypted communication, the encryption/decryption unit 511 acquires one encryption key from the one-time key storage unit 512 (S214). Then, the encryption/decryption unit 511 encrypts the share (converts the share into share information) by the one time pad method using the acquired encryption key (S215). Then, the encryption/decryption unit 511 transmits the share information to the reception site 42 via the transmission path (S218). After step S215, the one-time key information management unit 513 deletes the used encryption key from the one-time key storage unit 512 (S216). Then, the one-time key information management unit 513 subtracts 1 from the accumulation amount of the one time pad key (S217). On the other hand, in a case where it is determined in step S213 that the share is not a target of encrypted communication, the encryption/decryption unit 511 transmits the acquired share as share information to the reception site 42 via the transmission path (S219).

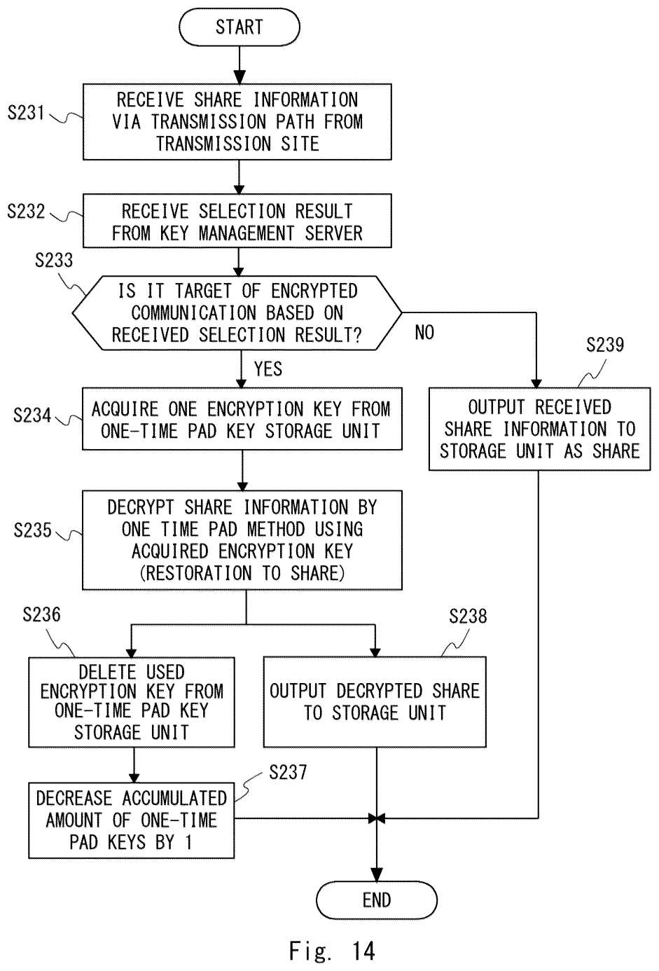

FIG. 14 is a flowchart illustrating a flow of processing of the transmission path protection unit 52 in the reception site 42. First, the transmission path protection unit 52 receives share information from the transmission site 41 via the transmission path (S231). For example, the transmission path protection unit 52 receives share information from the transmission path protection unit 51 in response to step S219 in FIG. 13. Then, the transmission path protection unit 52 receives the selection result from the key management server 200 (S232). Step S232 may be executed before step S231. It is assumed that the selection result received at least in step S232 has the same content as the selection result received in step S212 of FIG. 13 described above.

Subsequently, the encryption/decryption unit 521 determines whether the transmission section in which the own apparatus is present at one end is a target of encrypted communication based on the received selection result (S233). In a case where it is determined as a target of encrypted communication, the encryption/decryption unit 521 acquires one encryption key from the one-time key storage unit 522 (S234). Then, the encryption/decryption unit 521 decrypts (restores to share) the share information by the one time pad method using the acquired encryption key (S235). Then, the encryption/decryption unit 521 outputs the decrypted share to the storage unit (S238). After step S235, a one-time key information management unit 533 deletes the used encryption key from the one-time key storage unit 522 (S236). Then, the one-time key information management unit 533 subtracts 1 from the accumulation amount of the one time pad key (S237). On the other hand, in a case where it is determined as not a target of encrypted communication in step S233, the encryption/decryption unit 521 outputs the received share information to the storage unit as a share (S239).

As described above, according to the present example embodiment, not all the shares are encrypted, but only the minimum required shares are encrypted by the one time pad using the encryption key shared based on the quantum key distribution, whereby consumption of the encryption key shared based on the quantum key distribution can be suppressed.

By selecting a transmission sections of the number of encryption targets, it is also possible to suppress the number of encryption keys consumed in the one time pad in a case where an encryption key is shared by the key relay between a pair of communication apparatuses at both ends of each transmission section in advance. Furthermore, in the present example embodiment, by selecting the transmission section to be encrypted in consideration of the number of hops of the delivery route in the key relay, the amount of encryption keys consumed by the key relay can be suppressed. In particular, the selection accuracy of the transmission section can be further improved by narrowing down the plurality of delivery route candidates to the optimal delivery route in each transmission section.

### Other Example Embodiments

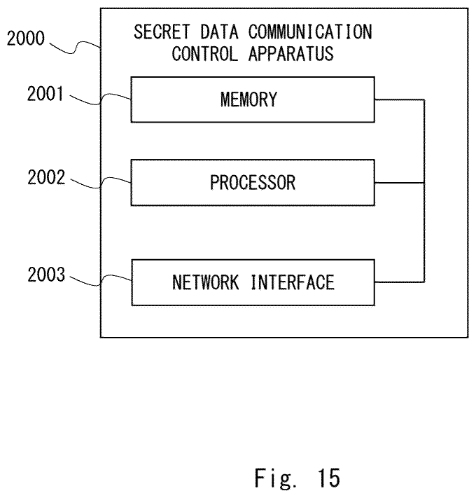

FIG. 15 is a block diagram illustrating a hardware configuration of a secret data communication control apparatus 2000. The secret data communication control apparatus 2000 is relevant to the secret data communication control apparatus 20 and the key management server 200 described above. The secret data communication control apparatus 2000 includes a memory 2001, a processor 2002, and a network interface 2003.

The memory 2001 is constituted by a combination of a volatile memory and a nonvolatile memory. The volatile memory is, for example, a volatile storage device such as a RAM, and is a storage area for temporarily storing information during an operation of the processor 2002. The nonvolatile memory is, for example, a nonvolatile storage device such as a hard disk or a flash memory. The memory 2001 stores at least a computer program in which the processing of the secret data communication control method in the secret data communication control apparatus 2000 according to the present disclosure is implemented. The memory 2001 may include a storage disposed away from the processor 2002. In this case, the processor 2002 may access the memory 2001 through an input/output (I/O) interface (not illustrated).

The processor 2002 is a control device that controls each component of the secret data communication control apparatus 2000. The processor 2002 reads and executes software (computer program) from the memory 2001. As a result, the processor 2002 implements the functions of the selection unit 21 and the encrypted communication control unit 22, or the QKDN management unit 231 and the encryption target selection unit 232 (optimal route selection unit 2321, transmission section sorting unit 2322, and target selection unit 2323). That is, the processor 2002 performs processing of the secret data communication control method in the secret data communication control apparatus 2000 according to the present disclosure. The processor 2002 may be, for example, a microprocessor, a multi processing unit (MPU), or a central processing unit (CPU). The processor 2002 may include a plurality of processors.

The network interface 2003 may be used to communicate with network nodes. The network interface 2003 may include, for example, a network interface card (NIC) conforming to IEEE 802.3 series. The IEEE represents Institute of Electrical and Electronics Engineers. The network interface 2003 may include a wireless local area network (LAN), a wired LAN, Wi-Fi (registered trademark), Bluetooth (registered trademark), and the like.

A (The) program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

While the present disclosure has been particularly shown and described with reference to example embodiments thereof, the present disclosure is not limited to the above-described example embodiments. It will be understood by those of ordinary skill in the art that various changes in form and details may be made therein without departing from the spirit and scope of the present disclosure as defined by the claims. And each example embodiment can be appropriately combined with at least one of example embodiments.

Each of the drawings is merely an example to illustrate one or more example embodiments. Each of the drawings is not associated with only one specific example embodiment, but may be associated with one or more other example embodiments. As those ordinary skilled in the art will appreciate, various features or steps described with reference to any one of the drawings may be combined with features or steps illustrated in one or more other drawings, for example, to create an example embodiment that is not explicitly illustrated or described. All of the features or steps illustrated in any one of the figures for explaining illustrative example embodiments are not necessarily mandatory, and some features or steps may be omitted. The order of the steps described in any of the figures may be changed as appropriate.

Some or all of the above-described example embodiments may be described as the following Supplementary Notes, but are not limited to the following Supplementary Notes.

### (Supplementary Note A1)

A secret data communication system including:
a selection means for selecting transmission sections of the number of encryption targets for encrypted communication from among transmission sections of a number of divisions relevant to each of divided data divided by secret distribution processing from predetermined data; and
an encrypted communication means for causing each of a pair of communication apparatuses at both ends of the selected transmission section to perform communication in which divided data relevant to the selected transmission section is encrypted using an encryption key shared between the pair of communication apparatuses based on quantum key distribution,
in which the number of encryption targets is equal to or more than a minimum number of the divided data to be restored to the predetermined data and less than the number of divisions.

### (Supplementary Note A2)

The secret data communication system according to Supplementary Note A1, in which the selection means is configured to execute selecting transmission sections of the number of encryption targets based on a delivery route in key relay of the encryption key to be shared based on the quantum key distribution in each transmission section.

### (Supplementary Note A3)

The secret data communication system according to Supplementary Note A2, in which the selection means is configured to execute selecting transmission sections of the number of encryption targets based on the number of hops of the delivery route.

### (Supplementary Note A4)

The secret data communication system according to Supplementary Note A3, in which
the selection means is configured to execute:
selecting the delivery routes from a top in ascending order of the number of hops to an order of the number of encryption targets; and
selecting a transmission section relevant to each of the selected delivery routes of the number of encryption targets.

### (Supplementary Note A5)

The secret data communication system according to Supplementary Note A3 or A4, in which the selection means is configured to execute:
selecting the delivery routes one by one based on a predetermined criterion from among a plurality of delivery route candidates in the key relay for each of the transmission sections of the number of divisions; and selecting the transmission sections of the number of encryption targets based on the number of hops of the selected delivery routes of the number of divisions.

### (Supplementary Note A6)

The secret data communication system according to Supplementary Note A5, in which the selection means is configured to execute selecting the delivery route for each of the transmission sections from among the plurality of delivery route candidates, with at least one of a number of accumulated encryption keys in the communication apparatus, the number of hops in the delivery route candidate, and a communication status between the pair of communication apparatuses as the predetermined criterion.

### (Supplementary Note A7)

The secret data communication system according to any one of Supplementary Notes A1 to A6, in which
the encrypted communication control means is configured to execute notifying each of the communication apparatuses of a selection result by the selection means
the communication apparatus is configured to execute:
determining, based on the notified selection result, whether the transmission section in which own apparatus is present at one end is a target of the encrypted communication;
performing communication in which divided data relevant to the transmission section is encrypted using the encryption key in a case where it is determined that the transmission section is a target of the encrypted communication; and
performing communication of divided data relevant to the transmission section in a case where it is determined that the transmission section is not a target of the encrypted communication.

### (Supplementary Note A8)

The secret data communication system according to Supplementary Note A7, in which
a transmission apparatus that is the communication apparatus on a transmission side of the transmission section is configured to execute:
transmitting encrypted data obtained by encrypting divided data relevant to the transmission section using the encryption key to a reception apparatus that is the communication apparatus on a reception side of the transmission section in a case where it is determined that the transmission section is a target of the encrypted communication; and
transmitting the divided data relevant to the transmission section to the reception apparatus in a case where it is determined that the transmission section is not a target of the encrypted communication, and
the reception apparatus is configured to execute:
acquiring the divided data by decrypting received data from the transmission apparatus using the encryption key in a case where it is determined that the transmission section is a target of the encrypted communication; and
acquiring, as the divided data, received data from the transmission apparatus in a case where it is determined that the transmission section is not a target of the encrypted communication.

### (Supplementary Note A9)

The secret data communication system according to any one of Supplementary Notes A1 to A8, in which the minimum number is larger than a half of the number of divisions.

### (Supplementary Note A10)

The secret data communication system according to any one of

Supplementary Notes A1 to A9, in which the number of encryption targets is a minimum number of the divided data to be restored to the predetermined data.

### (Supplementary Note A11)

The secret data communication system according to any one of Supplementary Note A1 to Note A10, in which the encrypted communication control means causes communication to be performed in which divided data relevant to the selected transmission section is encrypted by a one time pad using an encryption key shared based on the quantum key distribution.

### (Supplementary Note B1)

A secret data communication control apparatus including:
a selection means for selecting transmission sections of the number of encryption targets for encrypted communication from among transmission sections of a number of divisions relevant to each of divided data divided by secret distribution processing from predetermined data; and
an encrypted communication means for causing each of a pair of communication apparatuses at both ends of the selected transmission section to perform communication in which divided data relevant to the selected transmission section is encrypted using an encryption key shared between the pair of communication apparatuses based on quantum key distribution,
in which the number of encryption targets is equal to or more than a minimum number of the divided data to be restored to the predetermined data and less than the number of divisions.

### (Supplementary Note C1)

A secret data communication control method causing a computer to execute:
selecting transmission sections of the number of encryption targets for encrypted communication from among transmission sections of a number of divisions relevant to each of divided data divided by secret distribution processing from predetermined data; and
causing each of a pair of communication apparatuses at both ends of the selected transmission section to perform communication in which divided data relevant to the selected transmission section is encrypted using an encryption key shared between the pair of communication apparatuses based on quantum key distribution,
wherein the number of encryption targets is equal to or more than a minimum number of the divided data to be restored to the predetermined data and less than the number of divisions.

### (Supplementary Note D1)

A secret data communication control program causing a computer to execute:
selection processing of selecting transmission sections of the number of encryption targets for encrypted communication from among transmission sections of a number of divisions relevant to each of divided data divided by secret distribution processing from predetermined data; and
encrypted communication control processing of causing each of a pair of communication apparatuses at both ends of the selected transmission section to perform communication in which divided data relevant to the selected transmission section is encrypted using an encryption key shared between the pair of communication apparatuses based on quantum key distribution,
in which the number of encryption targets is equal to or more than a minimum number of the divided data to be restored to the predetermined data and less than the number of divisions.

Some or all of the elements (for example, the configurations and functions) described in Supplementary Notes A2 to A11 dependent on Supplementary Note A1 {e.g. system} can also be dependent on Supplementary Note B1 {e.g. apparatus}, Supplementary Note C1 {e.g. method}, and Supplementary Note D1 {e.g. program} by the same dependency relationship as Supplementary Notes A2 to A11. Some or all of the elements described in any Supplementary Note may be applied to various types of hardware components, software components, recording means for recording software components, systems, and methods.

What is claimed is:

1. A secret data communication system comprising:
at least one memory that stores commands; and
at least one processor that executes the commands, wherein
the at least one processor is configured to execute:
selecting transmission sections of the number of encryption targets for encrypted communication from among transmission sections of a number of divisions relevant to each of divided data divided by secret distribution processing from predetermined data; and
causing each of a pair of communication apparatuses at both ends of the selected transmission section to perform communication in which divided data relevant to the selected transmission section is encrypted using an encryption key shared between the pair of communication apparatuses based on quantum key distribution, and
the number of encryption targets is equal to or more than a minimum number of the divided data to be restored to the predetermined data and less than the number of divisions.

2. The secret data communication system according to claim 1, wherein the at least one processor is configured to execute selecting transmission sections of
the number of encryption targets based on a delivery route in key relay of the encryption key to be shared based on the quantum key distribution in each transmission section.

3. The secret data communication system according to claim 2, wherein the at least one processor is configured to execute selecting transmission sections of the number of encryption targets based on a number of hops of the delivery route.

4. The secret data communication system according to claim 3, wherein the at least one processor is configured to execute:
selecting the delivery routes from a top in ascending order of the number of hops to an order of the number of encryption targets; and
selecting a transmission section relevant to each of the selected delivery routes of the number of encryption targets.

5. The secret data communication system according to claim 3, wherein the at least one processor is configured to execute:
selecting the delivery routes one by one based on a predetermined criterion from among a plurality of delivery route candidates in the key relay for each of the transmission sections of the number of divisions; and
selecting the transmission sections of the number of encryption targets based on the number of hops of the selected delivery routes of the number of divisions.

6. The secret data communication system according to claim 5, wherein the at least one processor is configured to execute selecting the delivery route for each of the transmission sections from among the plurality of delivery route candidates, with at least one of a number of accumulated encryption keys in the communication apparatus, the number of hops in the delivery route candidate, and a communication status between the pair of communication apparatuses as the predetermined criterion.

7. The secret data communication system according to claim 1, wherein
the at least one processor is configured to execute notifying each of the communication apparatuses of a selection result of the transmission section,
the communication apparatus is configured to execute:
determining, based on the notified selection result, whether the transmission section in which own apparatus is present at one end is a target of the encrypted communication;
performing communication in which divided data relevant to the transmission section is encrypted using the encryption key in a case where it is determined that the transmission section is a target of the encrypted communication; and
performing communication of divided data relevant to the transmission section in a case where it is determined that the transmission section is not a target of the encrypted communication.

8. The secret data communication system according to claim 7, wherein
a transmission apparatus that is the communication apparatus on a transmission side of the transmission section is configured to execute:
transmitting encrypted data obtained by encrypting divided data relevant to the transmission section using the encryption key to a reception apparatus that is the communication apparatus on a reception side of the transmission section in a case where it is determined that the transmission section is a target of the encrypted communication; and
transmitting the divided data relevant to the transmission section to the reception apparatus in a case where it is determined that the transmission section is not a target of the encrypted communication, and
the reception apparatus is configured to execute:
acquiring the divided data by decrypting received data from the transmission apparatus using the encryption key in a case where it is determined that the transmission section is a target of the encrypted communication; and
acquiring, as the divided data, received data from the transmission apparatus in a case where it is determined that the transmission section is not a target of the encrypted communication.

9. The secret data communication system according to claim 1, wherein the minimum number is larger than a half of the number of divisions.

10. The secret data communication system according to claim 1, wherein the number of encryption targets is a minimum number of the divided data to be restored to the predetermined data.

11. The secret data communication system according to claim 1, wherein the at least one processor causes communication to be performed in which divided data relevant to the selected transmission section is encrypted by a one time pad using an encryption key shared based on the quantum key distribution.

12. A secret data communication control method causing a computer to execute:
selecting transmission sections of the number of encryption targets for encrypted communication from among transmission sections of a number of divisions relevant to each of divided data divided by secret distribution processing from predetermined data; and
causing each of a pair of communication apparatuses at both ends of the selected transmission section to perform communication in which divided data relevant to the selected transmission section is encrypted using an encryption key shared between the pair of communication apparatuses based on quantum key distribution,
wherein the number of encryption targets is equal to or more than a minimum number of the divided data to be restored to the predetermined data and less than the number of divisions.

13. A non-transitory computer-readable medium having stored therein a secret data communication control program causing a computer to execute:
selection processing of selecting transmission sections of the number of encryption targets for encrypted communication from among transmission sections of a number of divisions relevant to each of divided data divided by secret distribution processing from predetermined data; and
encrypted communication control processing of causing each of a pair of communication apparatuses at both ends of the selected transmission section to perform communication in which divided data relevant to the selected transmission section is encrypted using an encryption key shared between the pair of communication apparatuses based on quantum key distribution,
wherein the number of encryption targets is equal to or more than a minimum number of the divided data to be restored to the predetermined data and less than the number of divisions.
